(19) United States
(12) Patent Application Publication
(10) Pub. No.: US 2006/0204841 A1
(43) Pub. Date: Sep. 14, 2006

(54) Battery and method of manufacturing same

(75) Inventors: Kouichi Satoh, Kobe-shi (JP); Kazunari Ohkita, Osaka (JP); Tomohiko Yokoyama, Itano-gun (JP); Takaaki Ikemachi, Kobe-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 11/367,699

(22) Filed: Mar. 6, 2006

(30) Foreign Application Priority Data
Mar. 9, 2005 (JP) 2005-066176
Mar. 28, 2005 (JP) 2005-091931

(51) Int. Cl. H01M 2/26; H01M 2/08; H01M 10/04

(52) U.S. Cl. 429/161; 429/174; 429/175; 29/623.4; 29/623.2

(57) ABSTRACT

A battery includes an electrically-conductive battery can (1) for accommodating a spirally-wound electrode assembly (3) in which an electrolyte solution is impregnated. The battery can has an open end and a closed end, and to the open end, an electrically-conductive sealing plate (5) is fixed being insulated from the battery can (1). A positive electrode (31) and a negative electrode (33) project from respective opposing ends of the spirally-wound electrode assembly (3), and a positive electrode current collector plate (4) and a negative electrode current collector plate (2) are joined to the respective projecting edges of the electrodes (31), (33). Electrically-conductive leads (45), (46) connect the positive electrode current collector plate (4) and the sealing plate (5) together. The negative electrode current collector plate (2) and the battery can (1) are electrically connected to each other. In a surface of the sealing plate (5) facing the spirally-wound electrode assembly (3), one or more electrically-conductive connecting protrusions (53), (54), to which the leads (45), (46) are welded, are provided protruding toward the spirally-wound electrode assembly (3).

### BACKGROUND OF THE INVENTION

1. Field of the Invention

The present invention relates to a battery in which an electrode assembly serving as a power-generating element is accommodated in a battery can and electric power generated by the electrode assembly can be output through a positive electrode terminal and a negative electrode terminal, and to a method of manufacturing the battery. More particularly, the invention relates to a current collecting structure thereof.

2. Description of Related Art

In recent years, batteries capable of outputting a large current (high-power batteries) have been demanded for driving motors in power tools, power assisted bicycles, electric automobiles, and the like, not just for electronic devices such as mobile telephones, notebook computers, and PDAs. A commonly used current collecting structure for such high-power batteries is a so-called tabless structure, in which circular current collector plates are welded at the top- and bottom-end portions of an electrode assembly coiled in a cylindrical shape. An example of the battery having such a structure is shown in Japanese Published Unexamined Patent Application No. 2000-36319.

The specific configuration of the battery is as follows. As illustrated in FIG. 1, a wound-type electrode assembly 154 is accommodated inside a closed-bottom cylindrical battery can 151, which serves as the negative electrode. A sealing plate 153 is crimped to the open end of the battery can 151 together with an insulating member 156, and a positive electrode terminal 157 is attached to the sealing plate 153.

A positive electrode current collector plate 152a and a negative electrode current collector plate 152b, which are in a disk-like shape, are welded to respective ends of the electrode assembly 154. The negative electrode current collector plate 152b is welded to the bottom face of the battery can 151. One end of a lead 155 is welded to the inner surface of the positive electrode current collector plate 152a and the other end of the lead 155 is welded to the reverse surface of the sealing plate 153. In this way, electric power generated by the electrode assembly 154 can be output through the positive electrode terminal 157 and the bottom face of the battery can 151. Additionally, the sealing plate 153 has a through hole 158 formed therein, provided with a vent closure 159, which is released when the internal pressure exceeds a predetermined value.

To assemble the above-described conventional battery, first, the positive electrode current collector plate 152a, to which one end of the lead 155 is welded, and the negative electrode current collector plate 152b are welded to the respective ends of the electrode assembly 154. Then, the electrode assembly 154 is inserted into the battery can 151. Thereafter, the obverse surface of the negative electrode current collector plate 152b is welded to a bottom face of the battery can 151 by resistance welding, and the other end of the lead 155 is welded to the reverse surface of the sealing plate 153 by ultrasonic welding or laser welding.

Subsequently, the lead 155 is bent, and the sealing plate 153 is pushed into the battery can 151. In this state, the sealing plate 153 is crimped to the open end of the battery can 151 with the insulating member 156 placed between them, to thus complete the battery.

In a high-power battery such as described above, it is essential to reduce the resistance in the battery and to design the battery in such a structure that a large current can be output. Taking these matters into consideration, it is necessary to increase the electrode area and reduce the resistance in the electrode assembly 154, and moreover, it is very important to reduce the DC resistance component that occurs at the portion of the electrode assembly 154 where current collection is performed. However, with the above-described conventional battery, the lead 155 and the sealing plate 153 need to be welded together with the sealing plate 153 being tilted (in other words, the lead 155 and the sealing plate 153 need to be welded together while the plane of the open end of the battery can 151 and the sealing plate 153 are being kept substantially perpendicular to each other); therefore, the length of the lead 155, which is electrically connected to the electrode assembly 154, needs to be long, and moreover, the cross-sectional area of the lead 155 cannot be large because the welding becomes difficult if the thickness of the lead 155 is large. For these reasons, a problem arises with the conventional battery that the battery's internal resistance becomes large when outputting a large current, reducing the current value during charge-discharge operations.

Furthermore, in the process step of crimping the sealing plate 153 to the open end of the battery can 151, a complicated process has been necessary to bend the lead 155 so that the sealing plate 153 can be accommodated inside the battery can 151.

### BRIEF SUMMARY OF THE INVENTION

Accordingly, it is an object of the present invention to provide a battery that may be assembled easily and capable of reducing the internal resistance, and a method of manufacturing the battery.

In order to accomplish the foregoing and other objects, the present invention provides a battery comprising: an electrically-conductive cylindrical battery can having an open end and a closed end; an electrically-conductive sealing plate insulated from the battery can and fastened to the open end of the battery can; an electrode assembly accommodated in the battery can, the electrode assembly including electrodes having respective projecting edges, projecting from respective opposing ends of the electrode assembly and having different polarities; a first electrically-conductive current collector plate and a second electrically-conductive current collector plate joined to the respective protruding edges of the respective electrodes, the second electrically-conductive current collector plate being electrically connected to the battery can; and one or more electrically-conductive leads connecting the first current collector plate to the sealing plate, wherein the sealing plate has, on a surface thereof facing the electrode assembly, one or more electrically-conductive connecting protrusions to which the one or more leads are welded, the one or more connecting protrusions protruding toward the electrode assembly.

Providing a connecting protrusion in a surface of the sealing plate facing the electrode assembly in a direction toward the electrode assembly, as described above, makes it possible to weld the lead(s) and the sealing plate together without tilting the sealing plate (in other words, while the plane of the open end of the battery can and the sealing plate are being kept substantially parallel to each other), so the length of the lead(s) may be shorter. Thus, the length of the conductive path between the positive electrode current collector plate and the sealing plate becomes shorter than that in the conventional batteries. As a result, the electrical resistance in the conductive path decreases, reducing the internal resistance in the battery.

Moreover, in the process step of crimping the sealing plate to the open end of the battery can, the length of the lead that is to be bent will be less, making the assembling of the battery easier.

In order to accomplish the foregoing and other objects, the present invention also provides a battery comprising: an electrically-conductive cylindrical battery can having an open end and a closed end; an electrically-conductive sealing plate insulated from the battery can and fastened to the open end of the battery can; an electrode assembly accommodated in the battery can, the electrode assembly including electrodes having respective projecting edges, projecting from respective opposing ends of the electrode assembly and having different polarities; a first electrically-conductive current collector plate and a second electrically-conductive current collector plate, joined to the respective protruding edges of the respective electrodes, the second electrically-conductive current collector plate being electrically connected to the battery can; and an electrically-conductive lead connecting the first current collector plate to the sealing plate, wherein the lead protrudes and extends from a surface of the first current collector plate to the sealing plate so as to be perpendicular to the sealing plate, the sealing plate has a slit into which the lead is fitted, the slit formed at a position in the sealing plate corresponding to a position in the first current collector plate from which the lead protrudes, and the slit and the lead are welded together with the lead being fitted into the slit.

In the above-described configuration, the lead extends substantially perpendicularly to the sealing plate from the surface of the first current collector plate, and the lead and the slit formed in the sealing plate are fixed by welding. Consequently, the lead connects the first current collector plate and the sealing plate at the minimum distance. As a result, the length of the conductive path between the first current collector plate and the sealing plate becomes shorter than that in the conventional batteries and the electrical resistance in the conductive path reduces, making it possible to reduce the internal resistance of the battery.

Moreover, in the process step of crimping the sealing plate to the open end of the battery can, the lead does not need to be bent unlike the conventional batteries, making the assembling of the battery easier.

In order to accomplish the foregoing and other objects, the invention also provides a method of manufacturing a battery, comprising the steps of: providing one side of a first conductive plate with a lead extending from a surface of the first conductive plate to prepare a first current collector plate; providing a second conductive plate to prepare a second current collector plate; forming a connecting protrusion in one side of a third conductive plate to prepare a sealing plate; preparing an electrode assembly including electrodes that project from respective opposing ends of the electrode assembly and have different polarities; after preparing the electrode assembly, joining the first current collector plate and the second current collector plate to the respective projecting edges of the electrodes; inserting the electrode assembly to which the first current collector plate and the second current collector plate have been joined, into an electrically-conductive battery can from an open end of the battery can and joining the second current collector plate to a bottom portion of the battery can; welding the lead to the connecting protrusion formed in the sealing plate; and fastening the sealing plate to the open end of the battery can so that the sealing plate is insulated from the battery can.

With this method, the above-described battery may be fabricated easily.

In order to accomplish the foregoing and other objects, the invention also provides a method of manufacturing a battery, comprising the steps of: providing a first conductive plate with a lead formed so as to extend from a surface of the first conductive plate substantially perpendicularly to prepare a first current collector plate; providing a second conductive plate to prepare a second current collector plate; forming, in a third conductive plate, a slit into which the lead is fitted, to prepare a sealing plate; preparing an electrode assembly including electrodes, projecting from respective opposing ends of the electrode assembly and having different polarities; after preparing the electrode assembly, joining the first current collector plate and the second current collector plate to the respective projecting edges of the electrodes; inserting the electrode assembly to which the first current collector plate and the current collector plate have been joined, into a battery can from an open end of the battery can, and joining the second current collector plate to a bottom portion of the battery can; fitting the lead into the slit and thereafter welding the lead and the slit together at a portion where the lead and the slit are fitted; and fastening the sealing plate to the open end of the battery can so that the sealing plate is insulated from the battery can.

The above-described method eliminates the need for the complicated process necessary for the conventional batteries in the process step of crimping the sealing plate to the opening end of the battery can, making the assembling of the battery easier.

### BRIEF DESCRIPTION OF THE DRAWINGS

FIG. 1 is a cross-sectional view illustrating the configuration of a conventional cylindrical secondary battery;

FIG. 2 is an exploded perspective view of a lithium-ion secondary battery according to a first embodiment of the present invention;

FIG. 3 is an exploded perspective view of a spirally-wound electrode assembly;

FIG. 4 is a perspective view of a positive electrode current collector plate;

FIG. 5 is a cross-sectional view of the sealing plate shown in FIG. 2, taken along line A-A;

FIG. 6 is a cross-sectional view of the lithium-ion secondary battery according to the first embodiment of the present invention;

FIG. 7 is a view illustrating how an arc-shaped protruding portion of a positive electrode current collector plate is welded to a current collector's edge of its positive electrode side;

FIG. 8 is a cross-sectional view illustrating how the positive electrode current collector plate and a negative electrode current collector plate are joined to a spirally-wound electrode assembly;

FIG. 9 is a view illustrating how leads and connecting protrusions of the main part of a sealing plate of are welded together;

FIG. 10 is a cross-sectional view illustrating a lithium-ion secondary battery according to a second embodiment of the present invention;

FIG. 11 is a perspective view of a positive electrode current collector plate in the lithium-ion secondary battery according to the second embodiment;

FIG. 12 is a cross-sectional view illustrating how a positive electrode current collector plate and a negative electrode current collector plate are jointed to a spirally-wound electrode assembly;

FIG. 13 is a cross-sectional view illustrating how the spirally-wound electrode assembly to which the positive electrode current collector plate and the negative electrode current collector plate have been joined is accommodated in a battery can;

FIG. 14 is a cross-sectional view illustrating how a lead and the sealing plate are joined;

FIG. 15A is a perspective view illustrating a process step of joining a lead and the sealing plate;

FIG. 15B is another perspective view illustrating the process step of joining a lead and the sealing plate;

FIG. 16 is a view illustrating how a lead and the main part of the sealing plate are welded in Comparative Battery X;

FIG. 17 is a perspective view illustrating the positive electrode current collector plate in Comparative Battery X;

FIG. 18 is a perspective view illustrating a modified example of connecting protrusions of the main part of the sealing plate, according to the first embodiment;

FIG. 19 is a perspective view illustrating another modified example of a connecting protrusion of the main part of the sealing plate, according to the first embodiment;

FIG. 20 is perspective view illustrating a modified example of the positive electrode current collector plate according to the second embodiment;

FIG. 21 is a cross-sectional view illustrating a modified example of a lead according to the second embodiment; and

FIG. 22 is a cross-sectional view illustrating a battery to which another modified example the lead is applied, according to the second embodiment.

### DETAILED DESCRIPTION OF THE INVENTION

According to the present invention, a battery comprises: an electrically-conductive cylindrical battery can having an open end and a closed end; an electrically-conductive sealing plate insulated from the battery can and fastened to the open end of the battery can; an electrode assembly accommodated in the battery can, the electrode assembly including electrodes having respective projecting edges, projecting from respective opposing ends of the electrode assembly and having different polarities; a first electrically-conductive current collector plate and a second electrically-conductive current collector plate joined to the respective protruding edges of the respective electrodes, the second electrically-conductive current collector plate being electrically connected to the battery can; and one or more electrically-conductive leads connecting the first current collector plate to the sealing plate. The sealing plate has, on a surface thereof facing the electrode assembly, one or more electrically-conductive connecting protrusions to which the one or more leads are welded, the one or more connecting protrusions protruding toward the electrode assembly.

It is preferable that the number of the one or more leads is at least two.

Providing a plurality of leads increases the total cross-sectional area of the leads, leading to further reduction in the battery internal resistance.

It should be noted that if the thickness of the lead(s) is excessively great in the foregoing configuration, the welding becomes difficult. Therefore, the advantageous effect that originates from providing a plurality of leads with a simple configuration will be significant.

It is also preferable that the connecting protrusions be provided at respective positions corresponding to the leads.

When a plurality of the connecting protrusions are provided, the welding of the respective leads may be carried out more smoothly, and the length of the leads may be made shorter, making it possible to reduce the battery internal resistance further.

It is also possible that the lead(s) be integrally formed with the first current collector plate.

The invention also provides a battery as follows. The battery comprises: an electrically-conductive cylindrical battery can having an open end and a closed end; an electrically-conductive sealing plate insulated from the battery can and fastened to the open end of the battery can; an electrode assembly accommodated in the battery can, the electrode assembly including electrodes having respective projecting edges, projecting from respective opposing ends of the electrode assembly and having different polarities; a first electrically-conductive current collector plate and a second electrically-conductive current collector plate, joined to the respective protruding edges of the respective electrodes, the second electrically-conductive current collector plate being electrically connected to the battery can; and an electrically-conductive lead connecting the first current collector plate to the sealing plate. The lead protrudes and extends from a surface of the first current collector plate toward the sealing plate so as to be perpendicular to the sealing plate. The sealing plate has a slit into which the lead is fitted, and the slit is formed at a position in the sealing plate corresponding to a position in the first current collector plate from which the lead protrudes. The slit and the lead are fastened by welding with the lead being fitted into the slit.

The lead may be integrally formed with the first current collector plate.

More specifically, it is preferable that the lead is formed by incising and erecting a portion of the first current collector plate so that the portion is substantially perpendicular to the surface of the first current collector plate facing the sealing plate.

With this configuration, the lead can be made merely by providing a cut in a portion of the first current collector plate and bending that portion; therefore, the process of making the lead may be made simple.

It is also preferable that the lead(s) be fixed to a portion of the first current collector plate by welding so that the lead(s) is/are substantially perpendicular to the surface of the first current collector plate that faces the sealing plate side.

With this configuration, the lead(s) may be made thicker than the first current collector plate; therefore, the electrical resistance of the conductive path can be reduced further.

It should be noted that, in the present invention, the lead(s) is/are welded at the end face thereof, and therefore, the welding of the lead(s) and the sealing plate does not become difficult even when the thickness of the lead(s) is large. Consequently, it is possible to provide a plurality of leads, although there is little need for providing a plurality of leads.

In addition, it is preferable that, in the state in which the slit in the sealing plate and the lead are welded together, the fore-end face of the lead be flush with the outer surface of the sealing plate, or be located within the slit of the sealing plate.

This configuration, without the lead projecting out of the battery, enables the battery to be put into a device smoothly and moreover to prevent short circuiting external to the battery.

A method of manufacturing a battery according to the invention comprises the steps of: providing one side of a first conductive plate with a lead extending from a surface of the first conductive plate to prepare a first current collector plate; providing a second conductive plate to prepare a second current collector plate; forming a connecting protrusion in one side of a third conductive plate to prepare a sealing plate; preparing an electrode assembly including electrodes that project from respective opposing ends of the electrode assembly and have different polarities; after preparing the electrode assembly, joining the first current collector plate and the second current collector plate to the respective projecting edges of the electrodes; inserting the electrode assembly to which the first current collector plate and the second current collector plate have been joined, into an electrically-conductive battery can from an open end of the battery can and joining the second current collector plate to a bottom portion of the battery can; welding the lead to the connecting protrusion formed in the sealing plate; and fastening the sealing plate to the open end of the battery can so that the sealing plate is insulated from the battery can.

This method enables the above-described battery to be fabricated easily.

It is preferable that, in the step of welding the lead and the connecting protrusion, the length of an end part of the lead that juts out from an edge of the battery can be 3 mm or less.

As discussed above, since the lead and the connecting protrusion may be welded together with the sealing plate being kept substantially parallel to the plane of the open end of the battery can, the welding can be carried out easily even when the length of the end part of the lead that juts out from an edge of the battery can is 3 mm or less. Thus, the lead may be made short, the internal resistance of the battery can be reduced.

It is preferable that, in the step of welding the lead and the connecting protrusion, the lead and the connecting protrusion be welded by laser welding or ultrasonic welding.

By using laser welding or ultrasonic welding, the lead and the connecting protrusion can be welded firmly.

A method of manufacturing a battery in accordance with another aspect of the invention comprises the steps of: providing a first conductive plate with a lead formed so as to extend from a surface of the first conductive plate substantially perpendicularly to prepare a first current collector plate; providing a second conductive plate to prepare a second current collector plate; forming, in a third conductive plate, a slit into which the lead is fitted, to prepare a sealing plate; preparing an electrode assembly including electrodes, projecting from respective opposing ends of the electrode assembly and having different polarities; after preparing the electrode assembly, joining the first current collector plate and the second current collector plate to the respective projecting edges of the electrodes; inserting the electrode assembly to which the first current collector plate and the current collector plate have been joined, into a battery can from an open end of the battery can, and joining the second current collector plate to a bottom portion of the battery can; fitting the lead into the slit and thereafter welding the lead and the slit together at a portion where the lead and the slit are fitted; and fastening the sealing plate to the open end of the battery can so that the sealing plate is insulated from the battery can.

It is preferable that in the step of forming the lead, the length of the lead be defined by the following expression (1):
(1)

Distance between a surface of the first current collector plate that faces the sealing plate and an inner surface of the sealing plate<Length of the lead≦Distance between the surface of the first current collector plate that faces the sealing plate and an outer surface of the sealing plate.

This makes it possible to prevent the lead from projecting out of the battery; therefore, when the battery needs to be fitted into a device, it can be smoothly put into the device. Moreover, short circuiting external to the battery can be prevented.

It is preferable that, in the step of welding the lead and the slit, the lead and the slit be welded together by laser welding or ultrasonic welding.

By using laser welding or ultrasonic welding, the lead and the slit can be welded together firmly.

In addition, it is preferable that in the step of forming the lead, the length of the lead be defined by the following expression (2):
(2)

Lead length>Distance between a surface of the first current collector plate facing the sealing plate and an outer surface of the sealing plate,

and in the step of welding the welding the lead and the slit, a portion of the lead that projects out of the outer surface of the sealing plate is cut off, and subsequently the lead and the slit are welded.

Although it is desirable to fabricate a battery with restricting the lead length as defined by the foregoing expression (1), there may be a case in fabricating an actual battery in which the lead is absent in the slit of the sealing plate when welding the lead and the slit together, due to the conditions of the joining of the electrodes and the current collector plates or manufacturing errors in the components. In particular, the just-mentioned state tends to occur when the thickness of the sealing plate is made thin to improve the mass energy density of the battery. This problem may be obviated by adopting a technique in which, in the step of forming the lead, the lead length is restricted according to the expression (2), and in the step of welding the lead and the slit, the portion of the lead projecting out of the outer surface of the sealing plate is cut away.

In this case, it is preferable that laser welding be used for welding the lead and the slit together in the step of welding the lead and the slit.

Using laser welding to weld the lead and the slit together makes it possible to carry out the process of cutting away the portion of the lead projecting out of the outer surface and the process of welding the lead and the slit with the same laser equipment (although the conditions in the two processes such as laser power may vary); therefore, the fabrication of the battery can be performed smoothly.

The present invention makes it possible to prevent the current value during charge-discharge operations from lowering by reducing a battery's internal resistance (particularly the battery internal resistance when outputting a large current).

### First Embodiment

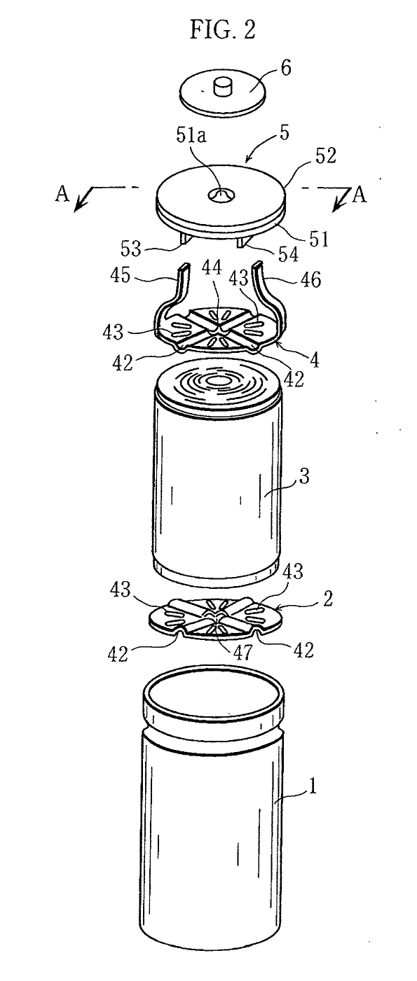

Hereinbelow, a first preferred embodiment of the present invention is described in further detail with reference to FIGS. 2 to 9. It should be construed, however, that the present invention is not limited to the following embodiment, and various changes and modifications are possible unless such changes and modifications depart from the scope of the invention.

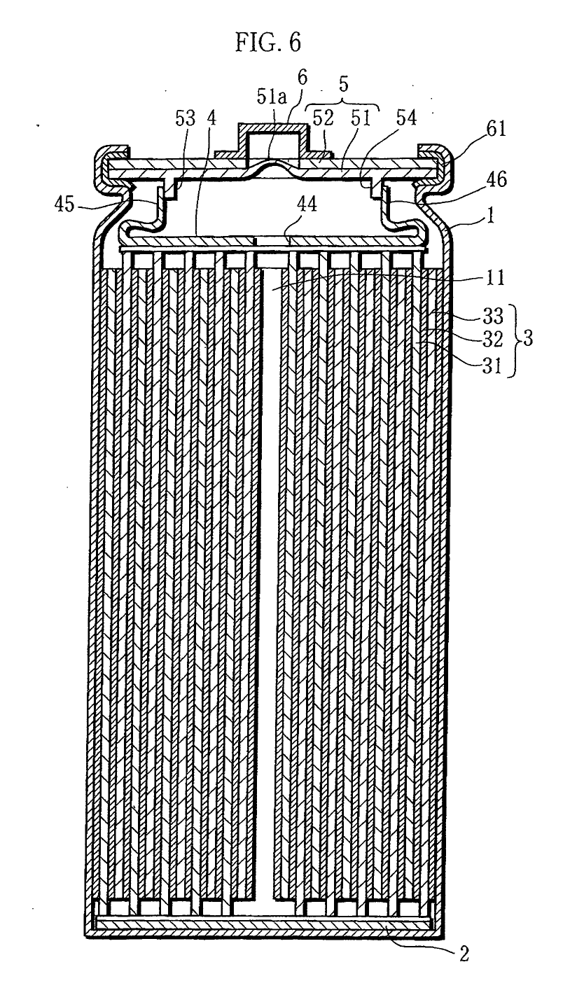

A lithium-ion secondary battery according to a first embodiment of the present invention is a cylindrical battery with a diameter of 18 mm and a height of 65 mm (battery capacity: about 1.5 Ah). As illustrated in FIGS. 2 and 6, within a battery can 1 in a closed-end cylindrical shape, a negative electrode current collector plate 2, a spirally-wound electrode assembly 3, a positive electrode current collector plate 4, and a sealing plate 5 are disposed in that order from the bottom up. A positive electrode terminal 6 is fixed to the sealing plate 5. The negative electrode current collector plate 2 serves as a second current collector plate while the a positive electrode current collector plate 4 serves as a first current collector plate. In the battery can 1, a non-aqueous electrolyte solution is accommodated in which LiPF₆ is dissolved at a concentration of 1 mol/L in a mixed solvent of a 1:1 volume ratio of ethylene carbonate and diethyl carbonate.

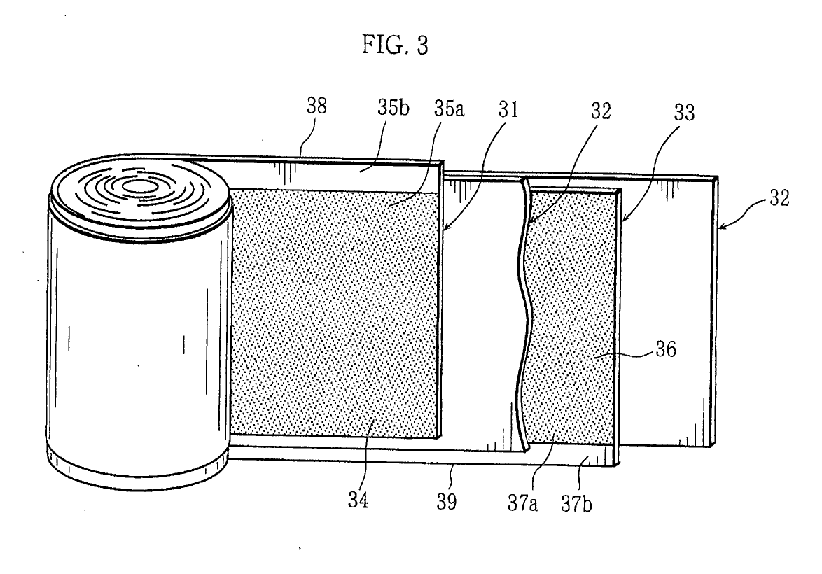

As illustrated in FIG. 3, the spirally-wound electrode assembly 3 is constructed by spirally winding a positive electrode 31 and a negative electrode 33, both of which are in a sheet shape, with respective sheet-shaped separators 32 interposed therebetween. The positive electrode 31 includes a sheet-shaped current collector 35 made of aluminum foil (thickness: 15 μm), and a positive electrode mixture 34 containing a lithium-containing composite oxide (lithium cobalt oxide) is coated on both sides of the sheet-shaped current collector 35. The negative electrode 33 includes a sheet-shaped current collector 37 made of a copper foil (thickness: 10 μm), and a negative electrode mixture 36 containing a carbon material is coated on both sides of the sheet-shaped current collector 37. The separator 32 is made of a porous polypropylene film.

The positive electrode 31 has a mixture-coated portion 35a, on which the positive electrode mixture 34 is coated, and a mixture-uncoated portion 35b, on which the positive electrode mixture 34 is not coated. Likewise, the negative electrode 33 has a mixture-coated portion 37a, on which the negative electrode mixture 36 is coated, and a mixture-uncoated portion 37b, on which the negative electrode mixture 36 is not coated. The positive electrode 31 and the negative electrode 33 are overlapped so as to be staggered with respect to the width of the separator 32, and the positive electrode 31, the negative electrode 33, and the separator 32 are spirally wound with the respective mixture-uncoated portions 35b and 37b of the positive and negative electrodes 31 and 33 projecting outwardly from respective side edges of the separator 32, whereby the spirally-wound electrode assembly 3 is constructed. The spirally-wound electrode assembly 3 has such a construction that, at one end, with respect to the winding axis, of the opposing ends of the spirally-wound electrode assembly 3, a current collector's edge 38 of the mixture-uncoated portion 35b of the positive electrode 31 projects outward from one side edge of the separator 32, while at the other end thereof, a current collector's edge 39 of the mixture-uncoated portion 37b of the negative electrode 33 projects outward from the other side edge of the separator 32.

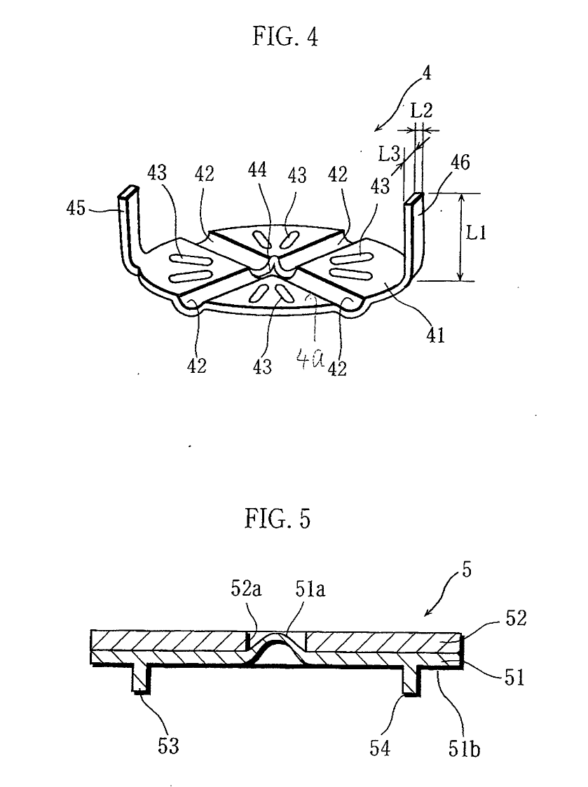

The positive electrode current collector plate 4 is made of a disk-shaped aluminum plate, and as illustrated in FIG. 4, it is provided with a circular plate-shaped main part 41. A plurality of radially extending, arc-shaped protruding portions 42, which project toward the spirally-wound electrode assembly 3, are integrally formed with the plate-shaped main part 41. In the plate-shaped main part 41, a center port 44 is formed, and a plurality of filling ports 43 are formed around the center port 44. At edge portions of the positive electrode current collector plate 4, strip-shaped leads 45 and 46 (the leads 45 and 46 oppose each other and have the same shape) are integrally formed with the positive electrode current collector plate 4. The length L1 of the leads 45 and 46 (the distance between fore-ends of the leads and a surface 4a of the positive electrode current collector plate 4 that opposes the sealing plate 5, as illustrated in FIG. 4) is 15 mm, the thickness L2 thereof is 0.4 mm, and the width L3 thereof is 3 mm. On the other hand, the negative electrode current collector plate 2 is formed of a disk-shaped nickel plate, and it differs from the positive electrode current collector plate 4 in that no strip-shaped leads 45 and 46 are provided, and that no center port is provided.

The protruding portions 42 of the two current collector plates 2 and 4 jam into the current collector's edges 38 and 39, which are formed at the respective ends of the spirally-wound electrode assembly 3. Joint surfaces that form cylindrical surfaces are formed between the protruding portions 42 and the current collector's edges 38, 39, and the joint surfaces are fixed by laser welding.

The sealing plate 5 has a disk-like shape and comprises, as illustrated in FIG. 5, a main part 51 made of aluminum and a lid portion 52 made of nickel and having a greater thickness than that of the main part 51. A dome-shaped vent closure 51a, which is thinner than the other part, is formed at the center of the main part 51. This is such a structure that, when the pressure inside the battery exceeds a predetermined value, the vent closure 51a breaks off to release the gas inside the battery to outside of the battery. In addition, substantially rectangular parallelpiped-shaped connecting protrusions 53 and 54 that are integrally formed with the main part 51 are formed on an inner side surface 51b of the sealing plate 5 (the surface thereof that faces the interior of the battery), and the connecting protrusions 53 and 54 are fixed to the leads 45 and 46 by laser welding.

Meanwhile, a through hole 52a into which the vent closure 51a of the main part 51 is fitted is formed at the center of the lid portion 52. The sealing plate 5 made of the lid portion 52 and the main part 51 is, as illustrated in FIG. 6, crimped to an open end of the battery can 1 with an insulating gasket 61 interposed therebetween. It should be noted that the lid portion 52 is not an essential component and the sealing plate 5 may be composed of only the main part 51.

The positive electrode terminal 6 is provided on a surface of the lid portion 52 so as to cover the through hole 52a. A plurality of vent holes (not shown) are formed in the outer circumferential face of the positive electrode terminal 6, whereby the gas inside the battery can be smoothly let out when the vent closure 51a is released.

Herein, the lithium-ion secondary battery according to the first embodiment is fabricated in the following manner.

First, a positive electrode mixture 34 composed of a lithium-containing composite oxide, a conductive agent, and a binder agent is coated on both sides of a sheet-shaped current collector made of aluminum foil, to thus prepare a positive electrode 31, and a negative electrode mixture 36 containing a carbon material and a binder agent is coated on both sides of a sheet-shaped current collector made of copper foil, to thus prepare a negative electrode 33. Thereafter, the positive and negative electrodes 31 and 33 were spirally wound with respective separators 32 interposed therebetween, to prepare a spirally-wound electrode assembly 3. The side edges of the positive electrode 31 and the negative electrode 33 are provided with respective mixture-uncoated portions 35b and 37b having a predetermined width. Concurrent with this process step, a positive electrode current collector plate 4 made of aluminum is prepared using a first conductive plate made of aluminum. A plurality of protruding portions 42 extending radially are formed in a 0.4 mm-thick plate-shaped main part 41 of the positive electrode current collector plate 4. A plurality of filling ports 43 are formed in the main part 41 with an aperture ratio of 50%. Further, strip-shaped leads 45 and 46 are provided extending from edges of the positive electrode current collector plate 4. Likewise, using a second conductive plate made of nickel, a negative electrode current collector plate 2 was prepared. Moreover, using a third conductive plate, a main part 51 of a sealing plate 5 is prepared in which connecting protrusions 53 and 54 are formed. Furthermore, using a fourth conductive plate, a lid portion 52 of the sealing plate 5 was prepared in which a through hole 52a is formed.

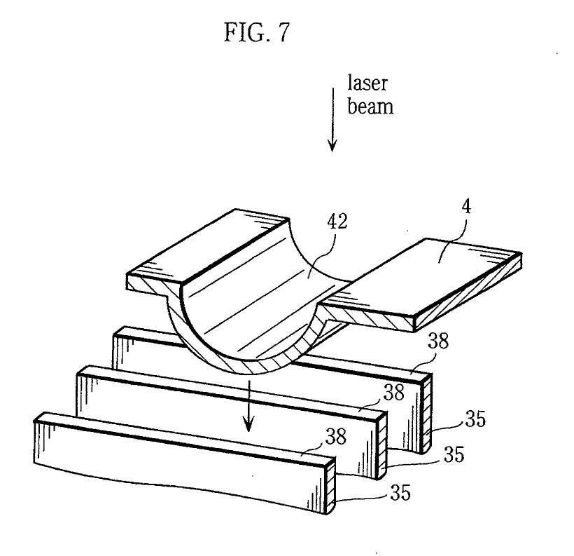

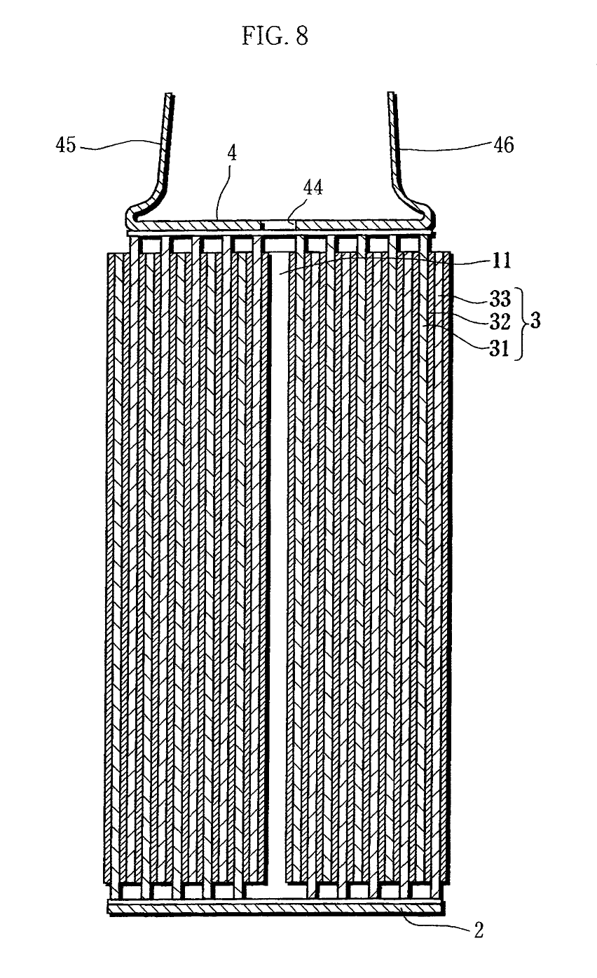

Next, as illustrated in FIG. 7, the positive electrode current collector plate 4 is placed over positive-electrode-side current collector's edge 38 of the spirally-wound electrode assembly 3 and is pressed with a jig from above, and thereafter, in this state, a laser beam (or an electron beam) is applied toward the inner round surface of a protruding portion 42 of the positive electrode current collector plate 4, to weld the outer circumferential face of the protruding portion 42 of the positive electrode current collector plate 4 to the current collector's edge 38. Likewise, the negative electrode current collector plate 2 is welded to the negative-electrode-side current collector's edge 39 in a similar manner to that for the positive electrode side. Thus, as illustrated in FIG. 8, the negative electrode current collector plate 2 and the positive electrode current collector plate 4 are welded to the respective edges of the spirally-wound electrode assembly 3.

Thereafter, the spirally-wound electrode assembly 3 to which both the current collector plates 2 and 4 have been attached is inserted into the battery can 1. Subsequently, a welding electrode (not shown) is inserted into a center port 44 of the positive electrode current collector plate 4 and a space 11 at the center of the spirally-wound electrode assembly 3, and a central portion 47 of the negative electrode current collector plate 2 is spot welded to the inner bottom face of the battery can 1. Then, a portion of the battery can 1 near its open end (a portion slightly upward of the positive electrode current collector plate 4) is subjected to a squeezing process.

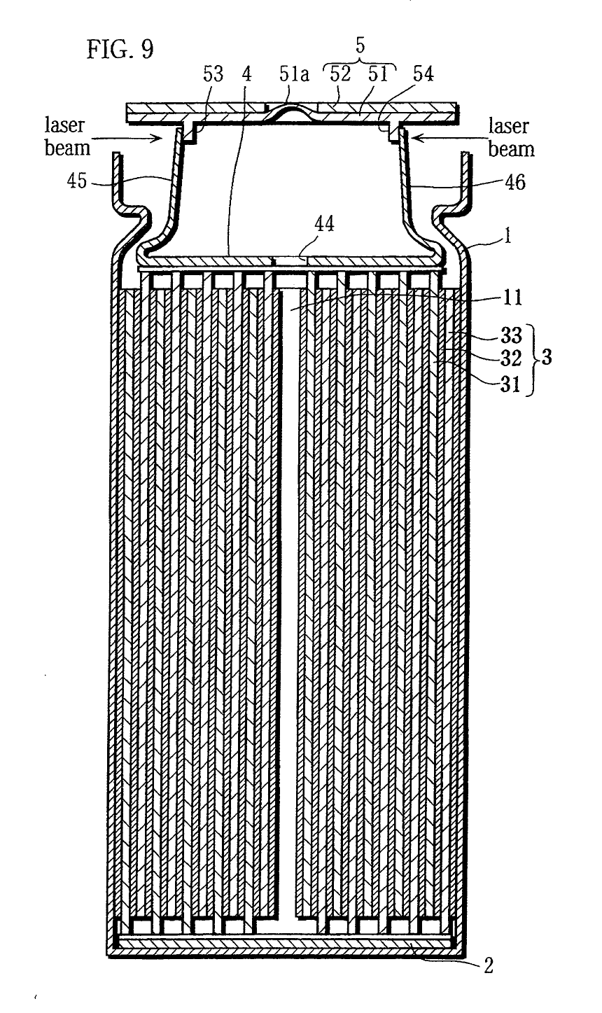

Thereafter, as illustrated in FIG. 9, the strip-shaped leads 45 and 46 provided extending from the positive electrode current collector plate 4 are on respective outer side faces of the substantially rectangular parallelpiped-shaped connecting protrusions 53 and 54 protruding from the lower surface of the main part 51 of the sealing plate 5 (the surface of the main part 51 facing the inside of the battery), and subsequently, a laser beam is applied thereto to weld together the connecting protrusions 53, 54 and the leads 45, 46. In this case, because both the connecting protrusions 53, 54 and the leads 45, 46 are made of the same material (aluminum), high weldability can be obtained and both parts can be fixed firmly.

Then, a non-aqueous electrolyte solution, in which LiPF₆ is dissolved at a concentration of 1 mol/L in a mixed solvent of 1:1 volume ratio of ethylene carbonate and diethyl carbonate, is filled into the battery can 1. An insulating gasket 61 is fitted onto the circumferential edge of the sealing plate 5, and the sealing plate 5 is disposed at the open end of the battery can 1. Finally, the upper end of the battery can 1 is crimped inwardly to seal the battery, whereby a lithium-ion secondary battery as illustrated in FIG. 6 is fabricated.

### Second Embodiment

Hereinbelow, a second embodiment of the present invention is described in further detail with reference to the drawings. It should be noted that similar parts to those in the first embodiment are indicated by the same reference numerals and are therefore not further elaborated here.

A lithium-ion secondary battery according to the second embodiment has the same configuration as that of the lithium-ion secondary battery according to the first embodiment except that it has a battery capacity of about 5 Ah and that the negative electrode current collector plate 2, the positive electrode current collector plate 4, and the sealing plate 5 have different structures. For this reason, the following description concerns only the differences.

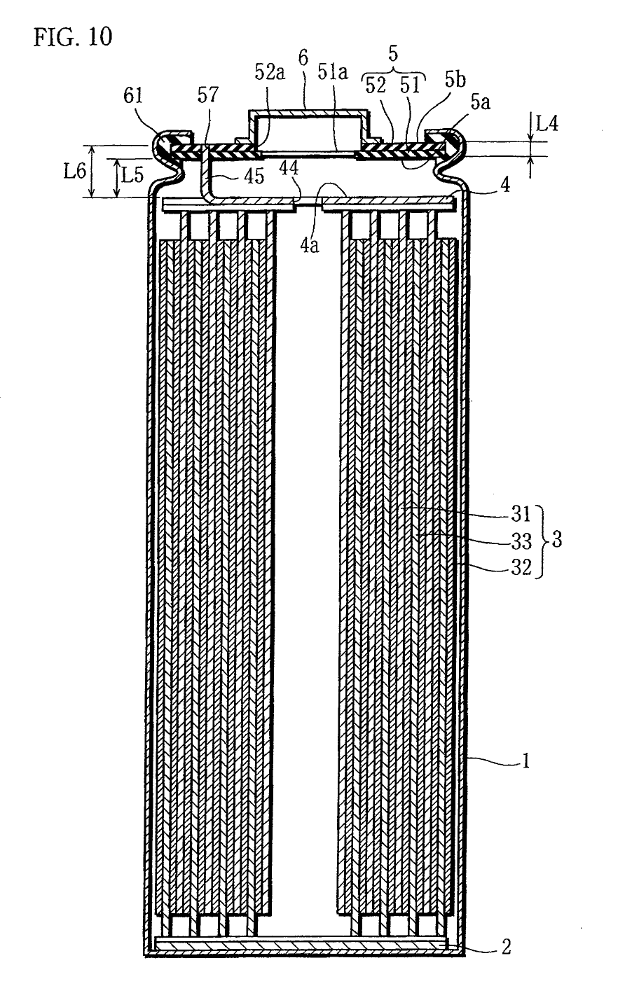

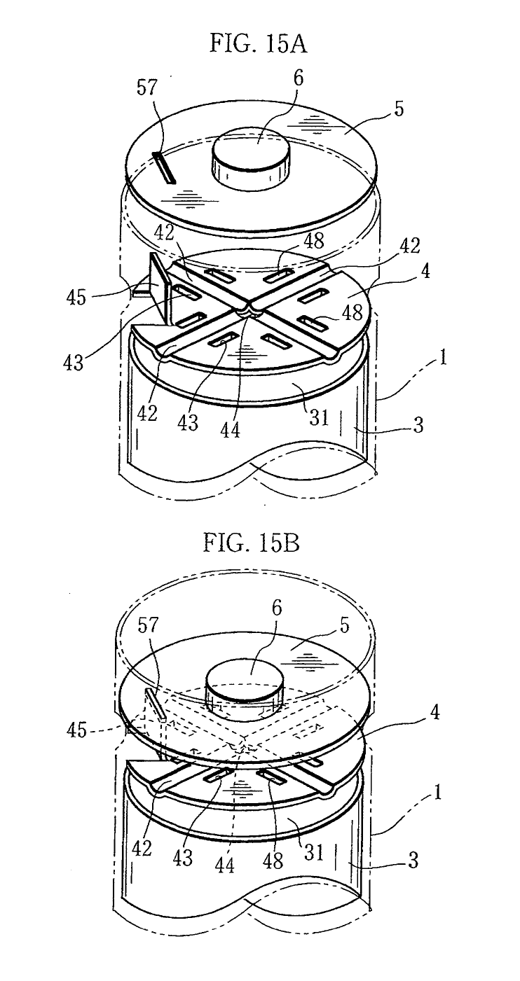

The positive electrode current collector plate 4 is different from that in the first embodiment in that: since a plate-shaped lead 45 is formed by incising and erecting a portion of the positive electrode current collector plate 4 perpendicularly to the surface thereof, as illustrated in FIGS. 10, 15A, and 15B, the lead 45 is not provided extending from the edge of the positive electrode current collector plate 4; that the number of the lead 45 is only one; and that a plurality of strips of incised-and-erected parts 48 are formed projecting toward the spirally-wound electrode assembly 3.

Forming the incised-and-erected parts 48 in this way makes it possible to establish electrically continuity between the incised-and-erected parts 48 and the current collector's edge of the spirally-wound electrode assembly 3, further enhancing the current collection performance. Such a configuration is employed because the battery according to the second embodiment, having a larger battery capacity than the battery according to the first embodiment, requires further improved current collection performance. It should be noted that such a configuration may be applied to the battery according to the first embodiment as well.

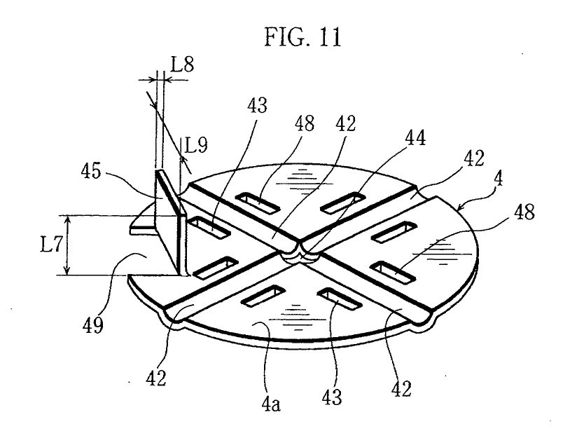

As illustrated in FIG. 11, the lead 45 extending from the edge of the positive electrode current collector plate 4 has a length L7 (the distance between the fore-end of the lead and the surface 4a of the positive electrode current collector plate 4 facing the sealing plate 5) of 10 mm, a thickness L8 of 0.5 mm, and a width L9 of 15 mm. The length L7 of the lead 45 is configured to be greater than the distance between the surface 4a of the positive electrode current collector plate 4 facing the sealing plate 5 and the inner side surface 5a of the sealing plate 5 (L5 in FIG. 10) and to be equal to or less than the distance between the surface 4a of the positive electrode current collector plate 4 facing the sealing plate 5 and the outer surface 5b of the sealing plate 5 (L6 in FIG. 10). Employing this configuration makes it possible to fit the lead 45 in a later-described slit 57, so that the laser welding can be carried out smoothly, and in addition, it prevents the lead 45 from projecting out of the battery, so that when the battery needs to be fitted into a device, it can be smoothly put into the device.

The sealing plate 5 is different from that of the first embodiment in that, as illustrated in FIGS. 10, 15A, and 15B, the main part 51 and the lid portion 52 thereof (the thickness L4 shown in FIG. 10 being 1.5 mm) are provided with a slit 57, into which the lead 45 is to be fitted, corresponding to the projecting position of the lead 45, and that the connecting protrusions 53 and 54 described in the first embodiment are not formed, associated with the provision of the slit 57.

Additionally, with the lead 45 being fitted into the slit 57 of the sealing plate 5, the lead 45 and the slit 57 are welded together at the portion where the lead 45 is fitted into the slit 57. The dimensions of the slit 57 are set to be greater by about 0.05 mm to 0.1 mm than the thickness L8 and the width L9 of the lead 45 so that the lead 45 can be smoothly fitted therein.

The negative electrode current collector plate 2 is different from that of the first embodiment in that it has a plurality of strips of incised-and-erected parts 48 projecting toward the spirally-wound electrode assembly 3. For the same reasons as discussed above about the positive electrode current collector plate 4, forming the incised-and-erected parts 48 makes it possible to further enhance the current collection performance.

Next, the method of manufacturing the lithium-ion secondary battery according to the second embodiment will be described below.

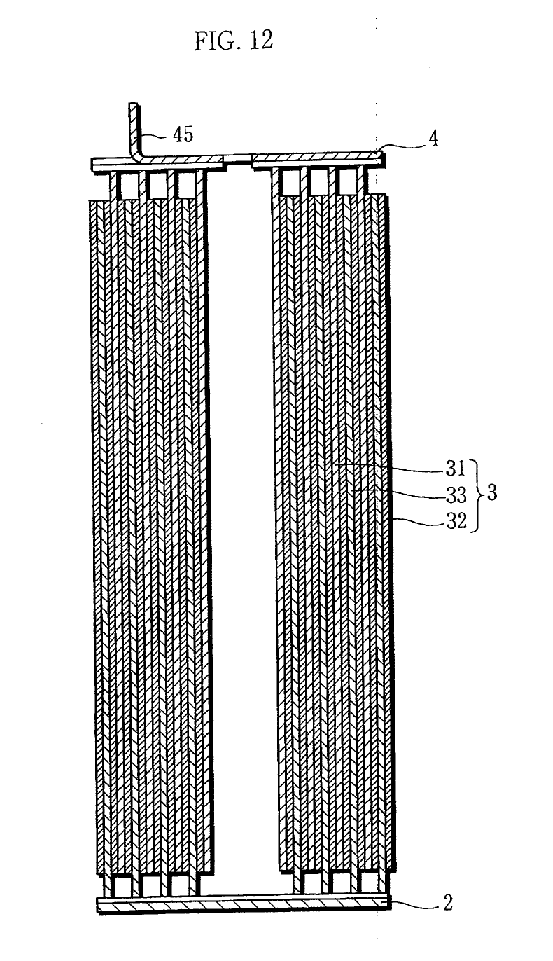

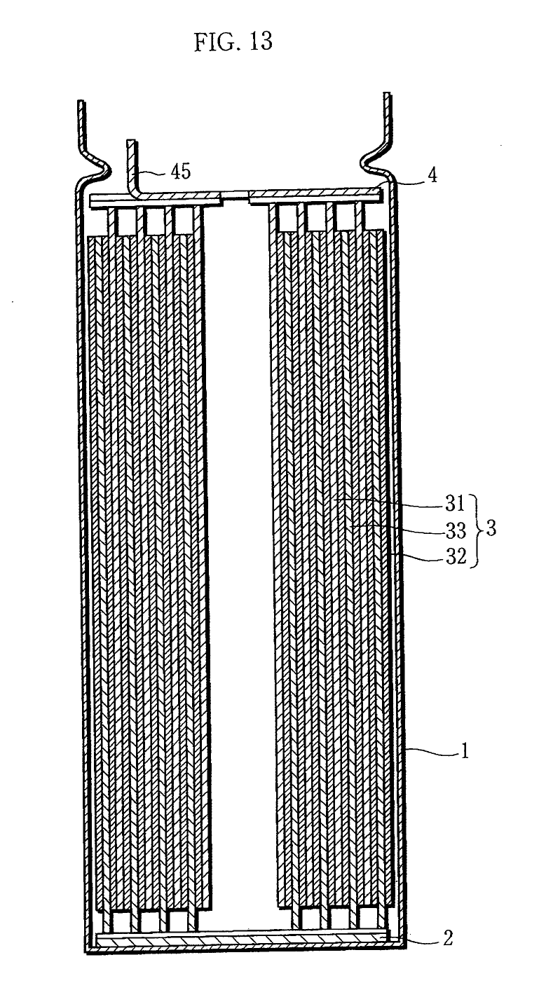

First, a battery can 1, a spirally-wound electrode assembly 3, current collector plates 2 and 4, and a sealing plate 5 are prepared. Then, as illustrated in FIG. 12, protruding portions 42 of both of the current collector plates 2 and 4 are joined to current collector's edges 38 of the spirally-wound electrode assembly 3. Next, as illustrated in FIG. 13, the spirally-wound electrode assembly 3 is inserted from the open end of the battery can 1 into the battery can 1, and thereafter, the negative electrode current collector plate 2 and the battery can 1 are joined together by resistance welding. Subsequently, a portion of the battery can 1 near the open end is subjected to a squeezing process. The above-described process steps are substantially the same as those in the first embodiment. Thereafter, an electrolyte solution is filled from the open end of the battery can 1 into the battery can 1.

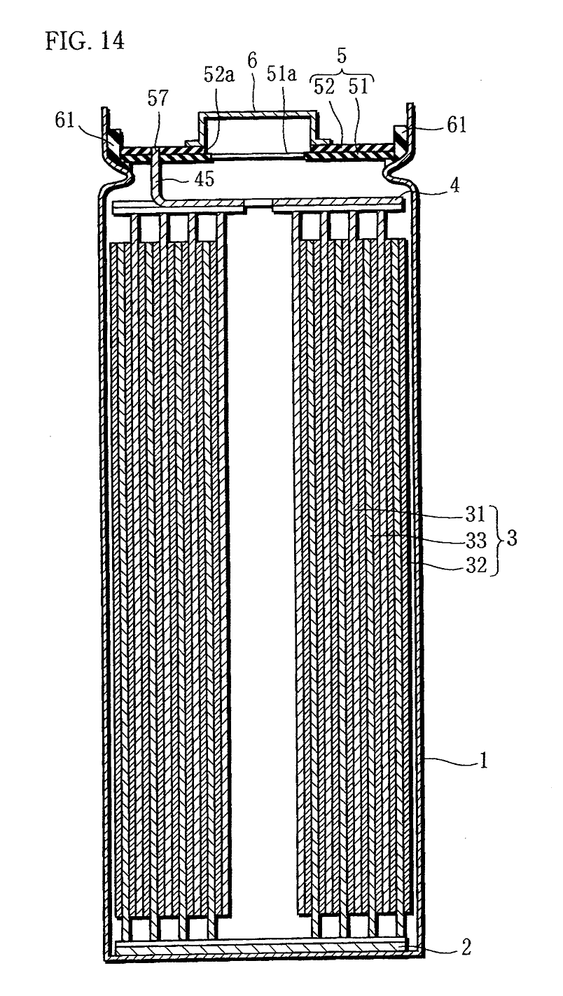

Next, as illustrated in FIG. 15A, the sealing plate 5 is disposed at the open end of the battery can 1 (note that although an insulating gasket 61 is not shown in FIG. 15A, the insulating gasket 61 is in fact disposed on the circumferential edge of the sealing plate 5, as shown in FIG. 14), and thereafter, as illustrated in FIGS. 14 and 15B, a lead 45 is fitted into a slit 57 of the sealing plate 5. At this point, the sealing plate 5 is positioned to be at such a position that, as illustrated in FIG. 15B, a surface thereof is substantially in the same plane as that of the fore-end surface of the lead 45, or that the fore-end surface is buried within the slit 57. This prevents the fore-end of the lead 45 from projecting out of the surface of the sealing plate 5 after the welding.

Then, in this state, a laser beam is applied from the open end side of the battery can 1 toward the portion where the lead 45 is fitted into the slit 57 of the sealing plate 5, whereby that portion is laser welded.

Here, all of the lid portion 52, the main part 51, and the lead 45, which constitute the sealing plate 5, are made of aluminum; thus, high weldability is attained since the surfaces of the lead 45 and the slit 57 of the sealing plate 5 that are in contact with each other are of the same material. Therefore, the lead 45 and the slit 57 can be firmly joined together at which they are fitted by laser welding.

Lastly, the upper end of the battery can 1 is crimped inwardly to seal the battery, and thus, a lithium-ion secondary battery as illustrated in FIG. 10 was fabricated.

### EXAMPLES

### Example A

A lithium-ion secondary battery as illustrated in the first embodiment was employed as Example A.

The battery thus prepared is hereinafter referred to as Battery A of the invention.

### Comparative Example X

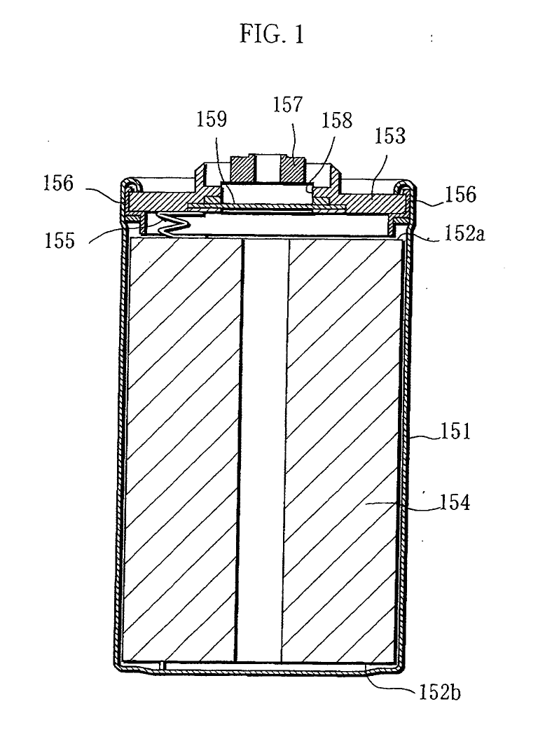

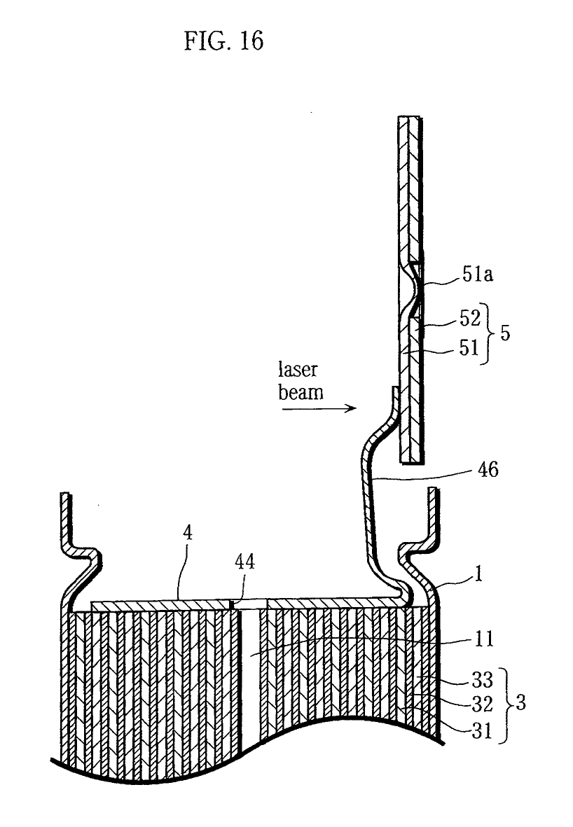

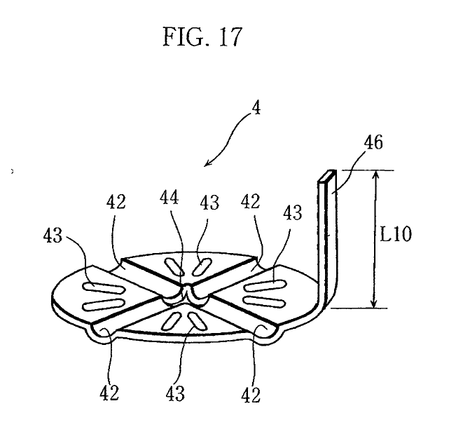

A lithium-ion secondary battery was fabricated in the same manner as Example A, except that, as illustrated in FIGS. 1, 16, and 17, no rectangular parallelpiped-shaped connecting protrusion was provided in a lower surface of the main part 51 of the sealing plate 5, that only one strip-shaped lead 46 was provided for the positive electrode current collector plate 4, and that the fore-end of the lead 46 was directed welded to the lower surface of the main part 51. In FIGS. 16 and 17, like components having the same functions as those in Battery A of the invention are designated by like reference numerals.

The battery thus fabricated is hereinafter referred to as Comparative Battery X.

### Experiment 1

The length of the lead and the resistance value (AC, 1 kHz) of the welded portion between the positive electrode current collector plate and the sealing plate were measured for each of Battery A of the invention and Comparative Battery X. The results are shown in Table 1.

TABLE 1

| | Lead length (mm) | Resistance (mΩ) |
|---|---|---|
| Battery A | 15 | 0.08 |
| Comparative Battery X | 25 | 0.25 |

As will be clearly understood from reviewing Table 1, the length of the leads 45 and 46 in Battery A of the invention (note that Battery A of the invention and Comparative Battery X had the same thickness and width of the leads 45 and 46, which were 0.4 mm and 3 mm, respectively) was 15 mm (L1 in FIG. 4), as compared to 25 mm (L10 in FIG. 17) for Comparative Battery X, demonstrating about a 40% reduction. The reason is as follows. Since Battery A of the invention is provided with the substantially rectangular parallelpiped-shaped connecting protrusions 53 and 54 in the lower surface of the sealing plate 5, the leads 45 and 46 and the sealing plate 5 can be welded together without tilting the sealing plate 5 (that is, with the positive electrode current collector plate 4 [the plane of the open end of the battery can 1] and the sealing plate 5 being kept substantially parallel to each other, or in other words, with the sealing plate 5 being substantially perpendicular to the axis of the spirally-wound electrode assembly 3); therefore, the length of the leads that are extended from the end surface of the positive electrode current collector plate 4 may be short (3 mm or less in Battery A of the invention). In contrast, since Comparative Battery X has no substantially rectangular parallelpiped-shaped connecting protrusion provided in the lower surface of the sealing plate 5, the lead 46 and the sealing plate 5 need to be welded together with the sealing plate 5 being tilted (that is, with the positive electrode current collector plate 4 [the plane of the open end of the battery can 1] and the sealing plate 5 being kept at a predetermined angle [about 90°], in other words, with the sealing plate 5 being substantially parallel to the axis of the spirally-wound electrode assembly 3); therefore, the length of the lead that extends from the end surface of the positive electrode current collector plate 4 needs to be long (13 mm in Comparative Battery X).

The resistance value of the welded portion between the positive electrode current collector plate 4 and the sealing plate 5 was also reduced in Battery A of the invention, 0.08 mΩ for Battery A of the invention, as compared to 0.25 mΩ for Comparative Battery X, demonstrating about a 70% reduction. This is believed to be attributed to the following. The length of the leads 45 and 46 is shorter in Battery A of the invention than that in Comparative Battery X. Moreover, Battery A of the invention has two leads 45 and 46 while Comparative Battery X has only one lead 46, and therefore, the cross-sectional area of the leads 45 and 46 of Battery A of the invention in total is two times that of Comparative Battery X.

It may seem possible to form two leads in Comparative Battery X, but it is not practical because in Comparative Battery X, the leads and the sealing plate need to be welded together with the sealing plate being tilted as discussed above, which makes the welding of the second lead extremely difficult.

### Example B

A lithium-ion secondary battery as illustrated in the second embodiment was employed as Example B.

The battery thus prepared is hereinafter referred to as Battery B of the invention.

### Comparative Example Y

A battery of comparative example had the same structure as that of Comparative Example X for the first embodiment above, except that the lead length was 30 mm, the lead width was 15 mm, the lead thickness was 0.5 mm, and the battery capacity was about 5.0 Ah. The length, width, and thickness of the lead were different from those of Comparative Example X for the first embodiment because of the difference in the battery capacities.

The battery thus fabricated is hereinafter referred to as Comparative Battery Y.

### Experiment 2

The resistance value (AC 1 kHz) of each battery was measured with Battery B of the invention and Comparative Battery Y. The results are shown in Table 2.

TABLE 2

| Battery | Lead length (mm) | Resistance (mΩ) |
|---|---|---|
| Battery B | 10 | 0.7 |
| Comparative Battery Y | 30 | 0.85 |

As will be clearly understood from reviewing Table 2, Battery B of the invention exhibits a smaller resistance value than Comparative Battery Y. The reason is that Comparative Battery Y has the same problem as the previously-described Comparative Battery X. The reason is believed to be as follows. In Comparative Battery Y, a clearance greater than a predetermined size is necessary between the surface of the positive electrode current collector plate and the reverse surface of the sealing plate in the process step of welding the fore-end of the lead to the reverse surface of the sealing plate. For this reason, the length of the lead must be sufficiently longer than the clearance between the surface of the positive electrode current collector plate and the reverse surface of the sealing plate that have been welded together (the length of the lead is 30 mm as mentioned above, and the lead width and lead thickness are the same as those of Battery B of the invention). It is believed that this increased the electrical resistance in the lead, which forms the conductive path between the positive electrode current collector plate and the sealing plate, consequently raising the internal resistance of Comparative Battery Y.

In contrast, in Battery B of the invention, the lead extends substantially linearly from the surface of the positive electrode current collector plate toward the sealing plate, and the length of the lead is only slightly longer than the clearance between the surface of the positive electrode current collector plate and the reverse surface of the sealing plate after they have been welded together (the length of the lead being 10 mm). Therefore, the length of the conductive path between the positive electrode current collector plate and the sealing plate is shorter than that in Comparative Battery Y It is believed that, as a result, the electrical resistance of the conductive path reduced, and the internal resistance of Battery B of the invention lowered.

Accordingly, the present invention makes it possible to reduce the resistance in the battery and as a consequence to manufacture a high power battery.

In addition, Comparative Battery Y requires that the lead needs to be formed longer than a predetermined length, and in the step of crimping the sealing plate to the open end of the battery can, a complicated process of bending the lead so that the sealing plate can be contained inside the battery can. In contrast, Battery B of the invention eliminates the need for this process, making the assembling of the battery easier.

Other Variations

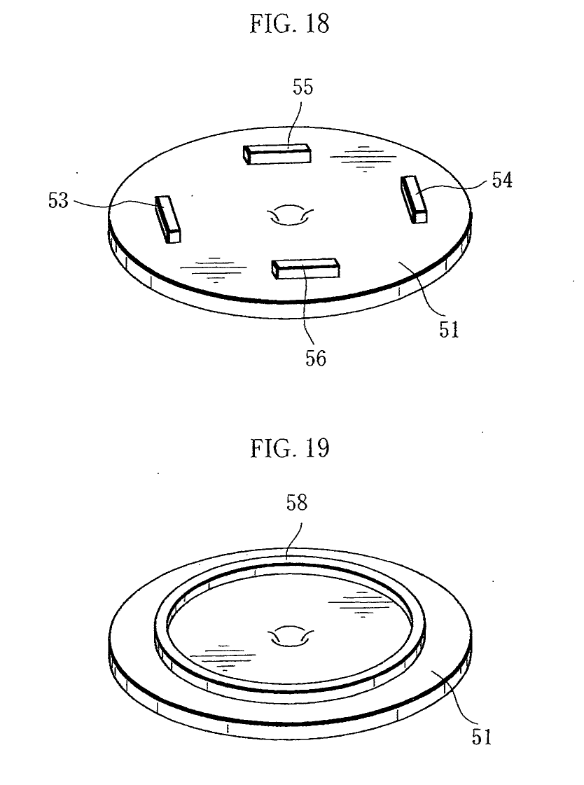

(1) Although the number of the leads is two in the first embodiment, it is possible to provide three, or even four or more leads. Such a configuration serves to reduce the resistance value between the positive electrode current collector plate and the sealing plate welded portion further. In this case, it is preferable that, as illustrated in FIG. 18, substantially rectangular parallelpiped-shaped connecting protrusions 53 to 56 be provided in the main part 51 of the sealing plate 5 corresponding to the number of the leads. As for the connecting protrusion, it is also possible to provide a single arc-shaped connecting protrusion 58, as illustrated in FIG. 19.

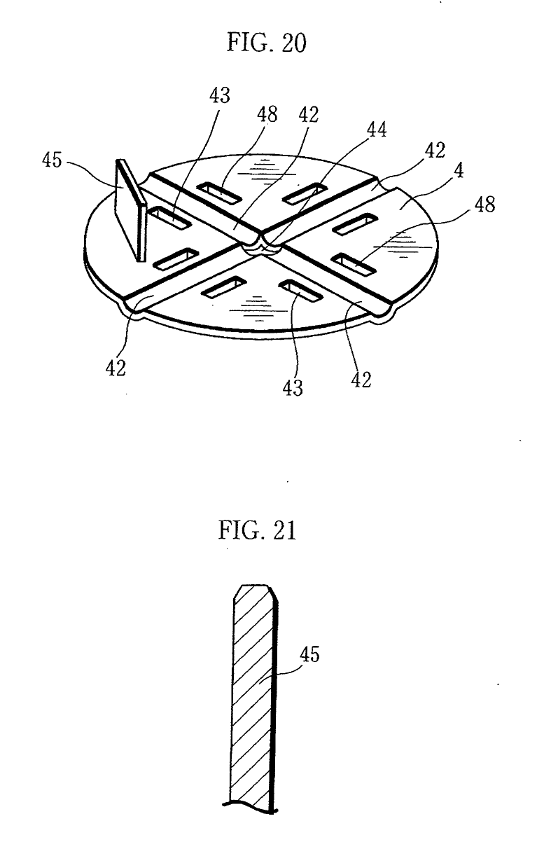

(2) In the second embodiment, the lead is formed by incising and erecting a portion of the disk-shaped positive electrode current collector plate, but this is not restrictive. It is also possible to adopt a configuration in which, as illustrated in FIG. 20, a lead 45 made of aluminum metal piece is prepared separately from the positive electrode current collector plate 4, and the lead 45 is welded to a surface of the positive electrode current collector plate 4. In this case, the thickness of the lead 45 may be easily made larger than the thickness of the positive electrode current collector plate 4, and therefore, the electrical resistance in the conductive path can be further reduced. In addition, in the case that the lead 45 is formed by incising and erecting a portion of the positive electrode current collector plate 4, an empty space remains in the portion that has been cut and erected (indicated by reference numeral 49 in FIG. 11). As a consequence, a laser beam might go through the space 49 to the spirally-wound electrode assembly 3 when welding the lead 45 and the sealing plate 5 together, degrading the battery performance. However, this problem is avoided by providing the lead 45 separately from the positive electrode current collector plate 4, as illustrated in FIG. 20, in which case the space 49 originating from the incising and erecting of the positive electrode current collector plate 4 does not form.

(3) It is preferable that in the second embodiment, the shape of the fore-end of the lead 45 be a tapered shape, as illustrated in FIG. 21. Employing such a shape makes it easier to fit the lead into the slit of the sealing plate.

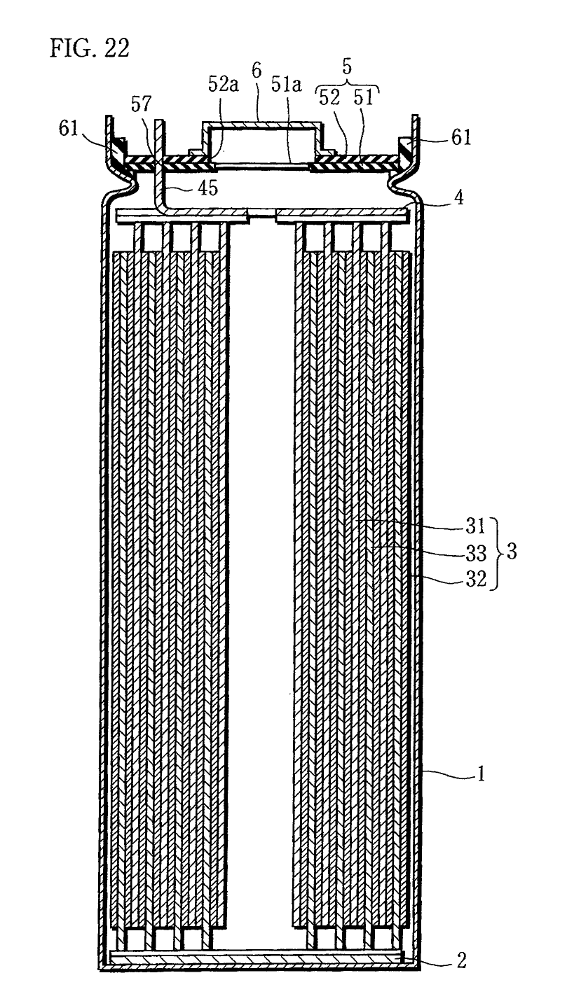

(4) In the second embodiment, as illustrated in FIG. 22, it is also possible to adopt a structure in which the lead 45 projects out of the sealing plate 5 and to cut away the portion of the lead 45 projecting out of the sealing plate 5 later. This configuration can prevent such a problem that the lead is absent in the slit of the sealing plate when welding the portion where the lead is fitted into the slit due to the conditions of the joining the electrodes and both the current collector plates and manufacturing errors of the components.

(5) The welding of the connecting protrusions and the leads in the first embodiment and the welding of the sealing plate and the lead in the second embodiment may be carried out not only by the above-mentioned laser welding but also by, for example, ultrasonic welding.

(6) In the first and second embodiments, the first current collector plate is the positive electrode current collector plate and the second current collector plate is the negative electrode current collector plate; however, of course possible that the first current collector plate may of course be the negative electrode current collector plate, and the second current collector plate be the positive electrode current collector plate.

(7) The present invention may be applicable not just to the above-described lithium-ion secondary battery but also to a wide range of batteries, including other types of secondary batteries such as nickel-cadmium storage batteries and nickel-hydrogen storage batteries, and primary batteries such as dry batteries and lithium batteries.

The present invention is applicable to large-sized batteries for, for example, in-vehicle power sources for electric automobiles or hybrid automobiles, as well as driving power sources for mobile information terminals such as mobile telephones, notebook computers, and PDAs.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A battery comprising:
an electrically-conductive cylindrical battery can having an open end and a closed end;
an electrically-conductive sealing plate insulated from the battery can and fastened to the open end of the battery can;
an electrode assembly accommodated in the battery can, the electrode assembly including electrodes having respective projecting edges, projecting from respective opposing ends of the electrode assembly and having different polarities;
a first electrically-conductive current collector plate and a second electrically-conductive current collector plate joined to the respective protruding edges of the respective electrodes, the second electrically-conductive current collector plate being electrically connected to the battery can; and
one or more electrically-conductive leads connecting the first current collector plate to the sealing plate,
wherein the sealing plate has, in a surface thereof facing the electrode assembly, one or more electrically-conductive connecting protrusions to which the one or more leads are welded, the one or more connecting protrusions protruding toward the electrode assembly.

2. The battery according to claim 1, wherein the number of the one or more leads is at least two.

3. The battery according to claim 2, wherein the one or more connecting protrusions are provided at positions corresponding to the leads.

4. The battery according to claim 1, wherein the one or more leads are formed integrally with the first current collector plate.

5. A battery comprising:
an electrically-conductive cylindrical battery can having an open end and a closed end;
an electrically-conductive sealing plate insulated from the battery can and fastened to the open end of the battery can;
an electrode assembly accommodated in the battery can, the electrode assembly including electrodes having respective projecting edges, projecting from respective opposing ends of the electrode assembly and having different polarities;
a first electrically-conductive current collector plate and a second electrically-conductive current collector plate, joined to the respective protruding edges of the respective electrodes, the second electrically-conductive current collector plate being electrically connected to the battery can; and
an electrically-conductive lead connecting the first current collector plate to the sealing plate,
wherein the lead protrudes and extends from a surface of the first current collector plate toward the sealing plate so as to be perpendicular to the sealing plate, the sealing plate has a slit into which the lead is fitted, the slit formed at a position in the sealing plate corresponding to a position in the first current collector plate from which the lead protrudes, and the slit and the lead are welded together with the lead being fitted into the slit.

6. The battery according to claim 5, wherein the lead is integrally formed with the first current collector plate.

7. The battery according to claim 6, wherein the lead is formed by incising and erecting a portion of the first current collector plate so as to be substantially perpendicular to a surface of the first current collector plate facing the sealing plate.

8. The battery according to claim 5, wherein the lead is composed of a metal piece and is fastened to a portion of the first current collector plate by welding so as to be substantially perpendicular to a surface of the first current collector plate facing the sealing plate side.

9. The battery according to claim 5, wherein a fore-end face of the lead is flush with an outer surface of the sealing plate, or is positioned within the slit of the sealing plate.

10. The battery according to claim 6, wherein a fore-end face of the lead is flush with an outer surface of the sealing plate, or is positioned within the slit of the sealing plate.

11. The battery according to claim 7, wherein a fore-end face of the lead is flush with an outer surface of the sealing plate, or is positioned within the slit of the sealing plate.

12. The battery according to claim 8, wherein a fore-end face of the lead is flush with an outer surface of the sealing plate, or is positioned within the slit of the sealing plate.

13. A method of manufacturing a battery, comprising the steps of:
providing one side of a first conductive plate with a lead extending from a surface of the first conductive plate to prepare a first current collector plate;
providing a second conductive plate to prepare a second current collector plate;
forming a connecting protrusion in one side of a third conductive plate to prepare a sealing plate;
preparing an electrode assembly including electrodes that project from respective opposing ends of the electrode assembly and have different polarities;
after preparing the electrode assembly, joining the first current collector plate and the second current collector plate to the respective projecting edges of the electrodes;
inserting the electrode assembly to which the first current collector plate and the second current collector plate have been joined, into an electrically-conductive battery can from an open end of the battery can and joining the second current collector plate to a bottom portion of the battery can;
welding the lead to the connecting protrusion formed in the sealing plate; and
fastening the sealing plate to the open end of the battery can so that the sealing plate is insulated from the battery can.

14. The method according to claim 13, wherein, in the step of welding the lead and the connecting protrusion, the length of an end part of the lead that juts out from an edge of the battery can is 3 mm or less.

15. The method according to claim 13, wherein, in the step of welding the lead and the connecting protrusion, the lead and the connecting protrusion are welded by laser welding or ultrasonic welding.

16. A method of manufacturing a battery, comprising the steps of:
providing a first conductive plate with a lead formed so as to extend from a surface of the first conductive plate substantially perpendicularly to prepare a first current collector plate;
providing a second conductive plate to prepare a second current collector plate;
forming, in a third conductive plate, a slit into which the lead is fitted, to prepare a sealing plate;
preparing an electrode assembly including electrodes, projecting from respective opposing ends of the electrode assembly and having different polarities;
after preparing the electrode assembly, joining the first current collector plate and the second current collector plate to the respective projecting edges of the electrodes;
inserting the electrode assembly to which the first current collector plate and the current collector plate have been joined, into a battery can from an open end of the battery can, and joining the second current collector plate to a bottom portion of the battery can;
fitting the lead into the slit and thereafter welding the lead and the slit together at a portion where the lead and the slit are fitted; and
fastening the sealing plate to the open end of the battery can so that the sealing plate is insulated from the battery can.

17. The method according to claim 16, wherein, in the step of forming the lead, the length of the lead is defined by the following expression (1):
(1)
Distance between a surface of the first current collector plate that faces the sealing plate and an inner surface of the sealing plate<Length of the lead≦Distance between the surface of the first current collector plate that faces the sealing plate and an outer surface of the sealing plate.

18. The method according to claim 17, wherein, in the step of welding the lead and the slit, the lead and the slit are welded together by laser welding or ultrasonic welding.

19. The method according to claim 16, wherein:
in the step of forming the lead, the length of the lead is defined by the following expression (2):
(2)
Lead length>Distance between a surface of the first current collector plate facing the sealing plate and an outer surface of the sealing plate
;and
in the step of welding the lead and the slit, a portion of the lead that projects out of the outer surface of the sealing plate is cut away, and subsequently the lead and the slit are welded together.

20. The method according to claim 19, wherein, in the step of welding the lead and the slit, the lead and the slit are welded together by laser welding.
